(19) United States
(12) Patent Application Publication
(10) Pub. No.: US 2023/0246325 A1
(43) Pub. Date: Aug. 3, 2023

(54) TERMINAL DEVICE AND ANTENNA MANUFACTURING METHOD OF TERMINAL DEVICE

(71) Applicant: ZTE CORPORATION, Shenzhen (CN)

(72) Inventor: Bin LI, Shenzhen (CN)

(21) Appl. No.: 17/999,750

(22) PCT Filed: Feb. 26, 2021
(86) PCT No.: PCT/CN2021/078079

§ 371 Date: Nov. 23, 2022

(30) Foreign Application Priority Data
May 26, 2020 (CN) 202010456663.X

(51) Int. Cl. H01Q 1/24; H01Q 1/38; H01Q 9/04

(52) U.S. Cl. CPC H01Q 1/243; H01Q 1/38; H01Q 9/0407

(57) ABSTRACT

A terminal device and an antenna manufacturing method for the terminal device are disclosed. The terminal device (100) may include a non-metal housing component (110); a Cold Plasma Spray (CPS) antenna layer (150), disposed on an outer side surface of the non-metal housing component (110); a mainboard (130), disposed on an inner side of the non-metal housing component (110); and a metal conduction member (120), penetrating through an inner side surface and the outer side surface of the non-metal housing component (110), one end of the metal conduction member (120) being electrically connected to the CPS antenna layer (150), and the other end of the metal conduction member (120) being electrically connected to the mainboard (130).

### CROSS-REFERENCE TO RELATED APPLICATION

This application is a national stage filing under 35 U. S.C. § 371 of international application number PCT/CN2021/078079, filed Feb. 26, 2021, which claims priority to Chinese patent application No. 202010456663.X filed May 26, 2020. The contents of these applications are incorporated herein by reference in their entirety.

### TECHNICAL FIELD

The present disclosure relates to the field of communications, and in particular to a terminal device and an antenna manufacturing method for the terminal device.

### BACKGROUND

As the functions of terminal devices become more and more powerful, various sensor devices, cameras and large-capacity batteries squeeze a space for arrangement of antennas inside the terminal devices. In addition, the terminal devices are increasingly focusing on thinness and high screen-to-body ratio, which makes the clearance space of antennas constantly compressed, and multiple antennas interfere with each other because of insufficient isolation, thus affecting communication performance.

At present, common antennas include a Flexible Printed Circuit (FPC) antenna, a Laser Direct Structuring (LDS) antenna, a Printed Direct Structuring (PDS) antenna, and the like. The FPC antenna can usually only be built in a terminal device. With the increasingly tight internal space of a terminal device, the FPC antenna can no longer meet the multi-band and large-quantity antenna requirements in structure. The LDS antenna may be disposed on a housing of the terminal device, but there are special requirements for material of a substrate of the housing. Moreover, the housing is easy to become brittle after chemical plating and electroplating, which leads to a risk of cracking of the housing. The PDS antenna may be disposed on the housing of the terminal device, but has requirements for cabling positions, and the reliability of cablings at corners is low, resulting in a waste of antenna arrangement space. Therefore, the above three antennas all have disadvantages in structure. With the advent of the 5G communication network era, in order to meet different needs of different countries, the terminal device is required to support more frequency bands. In this case, the number of antennas of the terminal device will inevitably increase significantly. It is obvious that the above three antennas can no longer meet antenna requirements of 5G terminal devices in structure.

### SUMMARY

The following is an overview of the subject described in detail in the present disclosure. This overview is not intended to limit the scope of protection of the claims.

Embodiments of the present disclosure provide a terminal device and an antenna manufacturing method for the terminal device, so as to solve a problem caused by insufficient antenna clearance space to at least a certain extent, ensuring the performance of terminal device antennas, and overcome the disadvantages existing in the existing antenna technology.

In accordance with an aspect of the present disclosure, an embodiment provides a terminal device. The terminal device may include: a non-metal housing component; a Cold Plasma Spray (CPS) antenna layer, disposed on an outer side surface of the non-metal housing component; a mainboard, disposed on an inner side of the non-metal housing component; and a metal conduction member, penetrating through an inner side surface and the outer side surface of the non-metal housing component, where a first end of the metal conduction member is electrically connected to the CPS antenna layer, and a second end of the metal conduction member is electrically connected to the mainboard.

In accordance with another aspect of the present disclosure, an embodiment provides an antenna manufacturing method for the terminal device. The method may include: placing a metal conduction member into a housing component mold, and performing injection molding by means of the housing component mold to obtain a non-metal housing component combined with the metal conduction member, where the metal conduction member penetrates through an inner side surface and an outer side surface of the non-metal housing component; forming an antenna cabling region on the outer side surface of the non-metal housing component by means of a laser process; and forming a CPS antenna layer on the antenna cabling region by means of a CPS process.

Other features and advantages of the present disclosure will be set forth in the following description, and partly become obvious from the description, or understood by implementing the present disclosure. The objects and other advantages of the present disclosure can be realized and obtained by the structure particularly pointed out in the description, claims and drawings.

### BRIEF DESCRIPTION OF DRAWINGS

The drawings are provided for a further understanding of the technical schemes of the present disclosure and constitute a part of the description. The drawings and the embodiments of the present disclosure are intended to illustrate the technical schemes of the present disclosure, and do not constitute a limitation to the technical schemes of the present disclosure.

FIG. 1 is a schematic cross-sectional structural diagram of a terminal device provided by an embodiment of the present disclosure;

FIG. 2 is a schematic partial structural diagram of a terminal device provided by an embodiment of the present disclosure;

FIG. 3 is a schematic partial structural diagram of a terminal device provided by an embodiment of the present disclosure;

FIG. 4 is a flowchart of an antenna manufacturing method for the terminal device provided by an embodiment of the present disclosure;

FIG. 5 is a flowchart of a step S200 in an antenna manufacturing method for the terminal device provided by an embodiment of the present disclosure;

FIG. 6 is a flowchart of a step S300 in an antenna manufacturing method for the terminal device provided by an embodiment of the present disclosure; and

FIG. 7 is a flowchart of another antenna manufacturing method for the terminal device provided by an embodiment of the present disclosure.

### DETAILED DESCRIPTION

In order to make the objects, technical schemes and advantages of the present disclosure clear, the present disclosure will be further described in detail with reference to the drawings and embodiments. It is to be understood that the specific embodiments described here are only used to illustrate the present disclosure, and are not intended to limit the present disclosure.

It is to be understood that in the description of the embodiments of the present disclosure, “a plurality of” (or multiple) means two or more, “greater than”, “less than”, “exceed” and the like are understood as excluding this number, and “above”, “below”, “within” and the like are understood as including this number. If the expressions “first”, “second” and the like are only used to distinguish technical features, such expressions cannot be understood as indicating or implying relative importance or an implied number of the indicated technical features or a sequence of the indicated technical features.

In the following description, suffixes such as “module”, “component” or “unit” used to represent elements are merely intended to facilitate description of the present invention, and have no particular meanings. Therefore, “module”, “component” or “unit” may be used interchangeably.

As the functions of terminal devices become more and more powerful, various sensor devices, cameras and large-capacity batteries squeeze a space for arrangement of antennas inside the terminal devices. In addition, the terminal devices are increasingly focusing on thinness and high screen-to-body ratio, which makes the clearance space of antennas constantly compressed, and multiple antennas interfere with each other because of insufficient isolation, thus affecting communication performance.

At present, common antennas include a Flexible Printed Circuit (FPC) antenna, a Laser Direct Structuring (LDS) antenna, a Printed Direct Structuring (PDS) antenna, and the like.

Due to the flexibility, the FPC antenna can be disposed on an inner side surface of an arc-shaped housing in a surface mounting mode. However, the mounting consistency is difficult to guarantee, and the FPC antenna can only be built in a terminal device. With the increasingly tight internal space of a terminal device, the FPC antenna can no longer meet the multi-band and large-quantity antenna requirements of the terminal in structure.

The LDS antenna can achieve flexible cabling, has relatively high adhesion, and does not have particularly high requirements for the shape of the housing. However, the LDS antenna has special requirements for plastic particles, so not all plastic housings can be used as a substrate of LDS antenna. Moreover, the housing is easy to become brittle after chemical plating and electroplating, which leads to a risk of cracking of the housing at a place where the thickness is reduced after an internal stress is released.

The PDS antenna has requirements for cabling positions, and the reliability of cablings at corners is low, resulting in a waste of antenna arrangement space.

Therefore, the above three antennas all have disadvantages in structure. With the advent of the 5G communication network era, in order to meet different needs of different countries, the terminal device is required to support more frequency bands. In this case, the number of antennas of the terminal device will inevitably increase significantly. It is obvious that the above three antennas can no longer meet antenna requirements of 5G terminal devices in structure.

In view of the above, embodiments of the present disclosure provide a terminal device and an antenna manufacturing method for the terminal device, so as to solve, at least to a certain extent, a problem caused by insufficient antenna clearance space, ensuring the performance of terminal antennas.

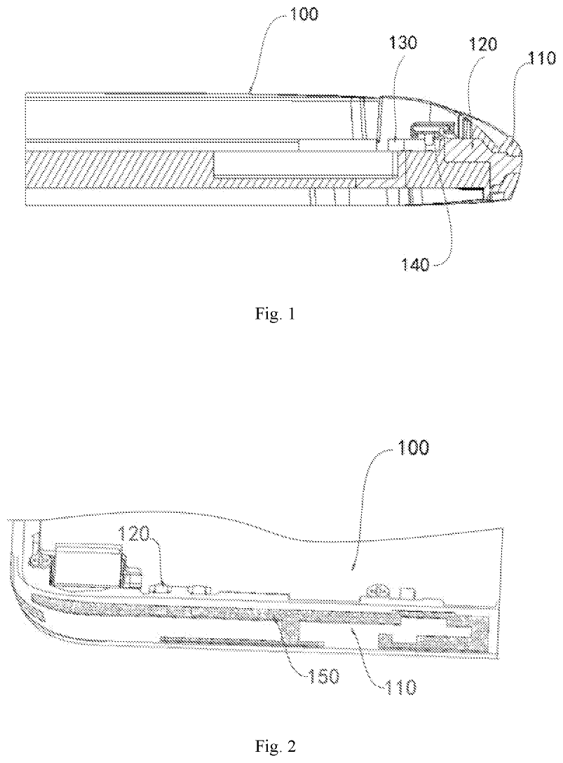

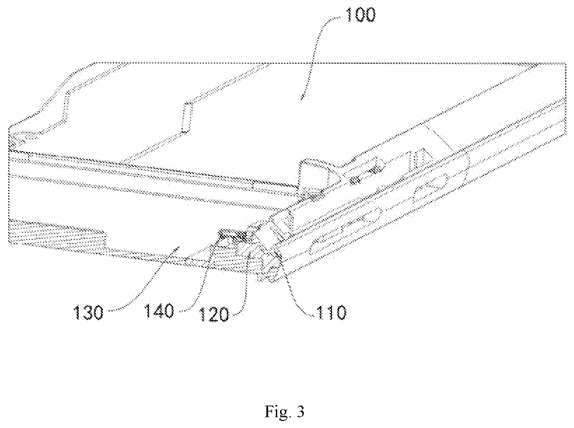

In accordance with an aspect of the present disclosure, an embodiment provides a terminal device. As shown in FIG. 1 to FIG. 3, the terminal device 100 includes a non-metal housing component 110, a Cold Plasma Spray (CPS) antenna layer 150, a mainboard 130 and a metal conduction member 120. The CPS antenna layer 150 is disposed on an outer side surface of the non-metal housing component 110. The mainboard 130 is disposed on an inner side of the non-metal housing component 110. The metal conduction member 120 penetrates through an inner side surface and the outer side surface of the non-metal housing component 110. A first end of the metal conduction member 120 is electrically connected to the CPS antenna layer 150, and a second end of the metal conduction member 120 is electrically connected to the mainboard 130.

It is to be understood that the terminal device 100 of the embodiment of the present disclosure may be an electronic device such as a smart phone, a tablet computer, a wearable device, a sports bracelet, a smart watch, a vehicle-mounted intelligent terminal and the like.

As shown in FIG. 1, in some embodiments, the non-metal housing component 110 may be a middle frame of the terminal device 100. It is to be understood that the middle frame is a part of a body structure of the terminal device 100. Generally, the middle frame is connected to a display screen and a rear cover of the terminal device 100, thus forming a body of the terminal device 100.

In some embodiments, the non-metal housing component 110 may also be a rear cover of the terminal device. It is to be understood that the rear cover is also a part of the body structure of the terminal device 100. Generally, the rear cover is connected to the middle frame and is located at the back of the body of the terminal device 100. In other embodiments, the non-metal housing component 110 may also be a housing integrally formed by a middle frame and a rear cover, which is not limited in the present invention.

It is to be understood that metal may shield transmitting and receiving signals of an antenna, thus affecting the signal quality of the antenna. Therefore, the embodiments of the present disclosure define that the housing component for disposing the CPS antenna layer 150 is made of non-metal material. For example, the non-metal housing component 110 may be made of plastic material.

It is to be understood that the CPS antenna layer 150 of the embodiments of the present disclosure is a metal layer manufactured by means of a CPS process and having an antenna function. The process of manufacturing the CPS antenna layer 150 by means of the CPS process is roughly as follows: a solid metal is gasified into metal gas at a high temperature, and the metal gas subjected to compression is sprayed onto a surface of the non-metal housing component 110 and is bonded to a substrate of the non-metal housing component 110, thus forming a metal layer attached to the substrate of the non-metal housing component 110. The metal layer has a shape matched with an antenna cabling pattern of a required frequency band, so that the metal layer has a function of an antenna. It is also to be understood that the CPS antenna layer 150 of the embodiments of the present disclosure includes antenna cablings of multiple frequency bands to meet the requirements of multiple-band antenna of the terminal device 100.

In an example, the CPS antenna layer 150 is made of any one or more of copper, tin, aluminum and zinc.

The antenna manufactured by means of a CPS process in the embodiments of the present disclosure can overcome respective disadvantages of the existing FPC antenna, LDS antenna and PDS antenna. For example, compared with the FPC antenna which can only be disposed inside the terminal device 100, the CPS antenna layer 150 of the embodiments of the present disclosure is disposed on an external surface of the terminal device 100. Compared with the LDS antenna, the CPS antenna layer 150 of the embodiments of the present disclosure has no special requirements for non-metal material, and can form a metal antenna layer without chemical plating or electroplating. Compared with the PDS antenna, the CPS antenna layer 150 of the embodiments of the present disclosure is formed by spraying a metal gas, which is easy to realize even at corners, and can ensure the reliability of cablings at the corners.

In an example, the mainboard 130 of the embodiments of the present disclosure is a Printed Circuit Board (PCB) disposed inside the body of the terminal device 100. Generally, the mainboard 130 of the terminal device 100 has integrated thereon electronic components such as a CPU, a power management chip, a baseband component, a radio frequency component, a Bluetooth component, and a Wireless Fidelity (WiFi) component.

In an example, the metal conduction member 120 of the embodiment of the present disclosure is embedded in the non-metal housing component 110 and penetrates through an inner side surface and an outer side surface of the non-metal housing component 110. One end of the metal conduction member 120 is electrically connected to the CPS antenna layer 150, and the other end of the metal conduction member is electrically connected to the mainboard 130, thus realizing signal communication between the CPS antenna layer 150 and the mainboard 130. For example, a radio frequency signal received by the CPS antenna layer 150 is transmitted to the radio frequency component of the mainboard 130 through the metal conduction member 120 for processing, and the radio frequency signal output by the radio frequency component of the mainboard 130 is transmitted to the CPS antenna layer 150 through the metal conduction member 120 for transmission.

In some embodiments, the mainboard 130 is provided with a metal elastic connector 140. The metal elastic connector 140 may be provided on the mainboard 130 in the form of a patch. A first end of the metal elastic connector 140 is connected to the mainboard 130, a second end of the metal elastic connector 140 elastically contacts with the metal conduction member 120, and the metal conduction member 120 is electrically connected to the mainboard 130 through the metal elastic connector 140.

In an example, the metal elastic connector 140 may be disposed on a side of the mainboard 130 close to the metal conduction member 120. When the mainboard 130 is installed on the inner side of the non-metal housing component 110, the metal elastic connector 140 comes into contact with the metal conduction member 120 embedded in the non-metal housing component 110, and tightly abuts a feed point on the metal conduction member 120 by means of the elasticity of the metal elastic connector 140. In this way, the metal conduction member 120 can realize reception and transmission of radio frequency signals between the antenna and the mainboard 130 together with the metal elastic connector 140.

It is to be understood that the metal conduction member 120 and the metal elastic connector 140 in the embodiments of the present disclosure are provided in multiple in a one-to-one correspondence, and each metal conduction member 120 is correspondingly connected to an antenna cabling for each frequency band in the CPS antenna layer 150.

In some embodiments, the end of the metal conduction member 120 electrically connected to the CPS antenna layer 150 is flush with the outer side surface of the non-metal housing component 110, so as to ensure the flatness of the appearance of the terminal device 100.

In some embodiments, the outer side surface of the non-metal housing component 110 is further provided with a topcoat layer, and the CPS antenna layer 150 is covered by the topcoat layer.

According to the technical scheme of the embodiment of the present disclosure, the CPS antenna layer 150 is disposed on the non-metal housing component 110 of the terminal device 100, the CPS antenna layer 150 being a metal layer manufactured by means of a CPS process and having an antenna function. The CPS antenna layer 150 can overcome the disadvantages of the traditional FPC antenna, LDS antenna and PDS antenna, realize the arrangement of the antennas from the internal space of the terminal device 100 to the external surface of the terminal device 100, and can effectively solve a problem of insufficient antenna clearance space caused by tight internal space of the terminal device 100, ensuring the performance of antennas.

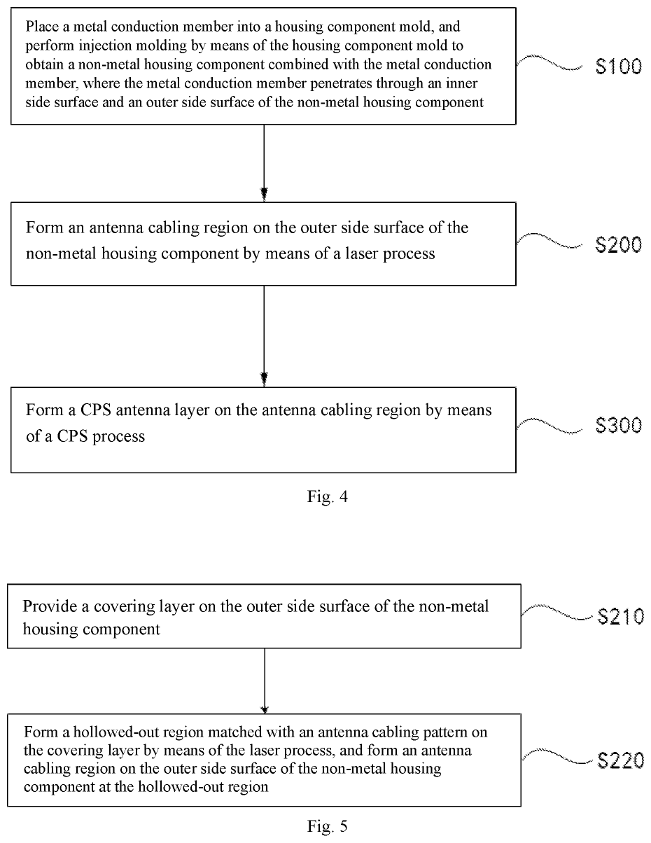

In accordance with another aspect of the present disclosure, an embodiment provides an antenna manufacturing method for the terminal device. The method is applied to the terminal device provided above in the embodiments of the present disclosure. As shown in FIG. 4, the method includes, but is not limited to, following steps S100 to S300.

At S100, a metal conduction member is placed into a housing component mold, and injection molding is performed by means of the housing component mold to obtain a non-metal housing component combined with the metal conduction member, where the metal conduction member penetrates through an inner side surface and an outer side surface of the non-metal housing component.

It is to be understood that the housing component mold is an injection mold for preparing non-metal housing components. In an example, in the method of the embodiment of the present disclosure, the metal conduction member is placed into the housing component mold first; then molten plastic material is injected into the non-metal housing component, solidified and cooled, to obtain a finished product of the non-metal housing component embedded with the metal conduction member, where the metal conduction member penetrates through an inner side surface and an outer side surface of the non-metal housing component. In this example, the metal conduction member is integrally molded with the non-metal housing component, so the combination of the metal conduction member and the non-metal housing component has high reliability.

In a possible implementation, for the finished product of the non-metal housing component manufactured in step S100, one end of the metal conduction member protrudes out of the outer side surface of the non-metal housing component, and a protruding height may be 0.1 mm to 1 mm. The end of the metal conduction member protruding out of the outer side surface of the non-metal housing component is a feed point for electrically connecting to the subsequently formed CPS antenna layer. In this case, after S100, a step S100B is further included. At S100B, the part of the metal conduction member protruding out of the outer side surface of the non-metal housing component is polished, so that one end of the metal conduction member is flush with the outer side surface of the non-metal housing component. In the implementation, one end of the metal conduction member is allowed to protrude out of the outer side surface of the non-metal housing component first, and then the protruding part is polished to be flush with the outer side surface of the non-metal housing component. This implementation is easier to realize in the production process, requires low production accuracy, is more feasible for mass production, and has more cost advantages.

Of course, in other possible implementations, the metal conduction member may be directly made to be flush with the outer side surface of the non-metal housing component through precise accuracy control. The metal conduction member may be made to indent into the outer side surface of the non-metal housing component, and the indented part may be filled through the subsequent CPS antenna layer.

At S200, an antenna cabling region is formed on the outer side surface of the non-metal housing component by means of a laser process.

In an example, an antenna cabling region is made on the outer side surface of the non-metal housing component by means of a laser process according to a pre-designed antenna cabling pattern so as to prepare for the subsequent formation of the CPS antenna layer.

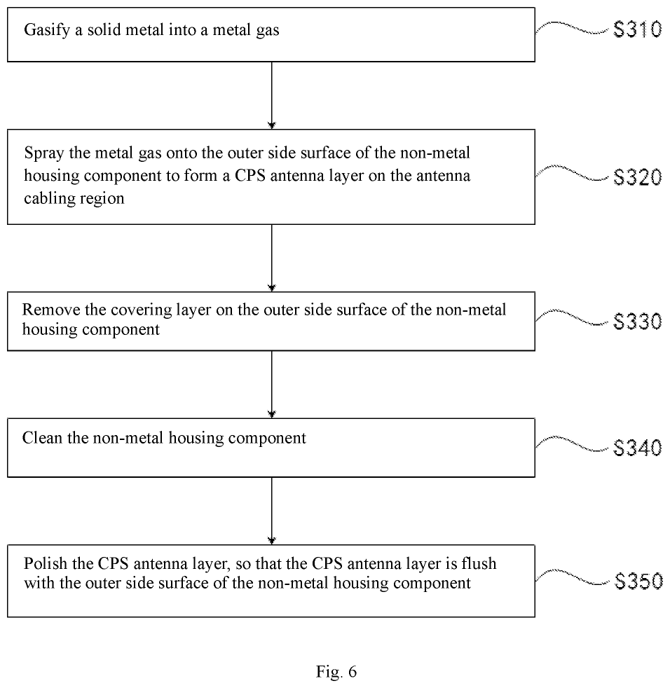

For example, as shown in FIG. 5, S200 may include following sub-steps S210 and S220.

At S210, a covering layer is provided on the outer side surface of the non-metal housing component.

In an example, the covering layer can be a covering film, such as a PET film or a PE film. In an implementation, adhesive is provided on one surface of the covering film, and then the covering film is adhered on the outer side surface of the non-metal housing component.

At S220, a hollowed-out region matched with the antenna cabling pattern is formed on the covering layer by means of the laser process, and the antenna cabling region is formed on the outer side surface of the non-metal housing component at the hollowed-out region.

In an example, the hollowed-out region matched with the pre-designed antenna cabling pattern may be carved on the covering layer by means of the laser process according to the antenna cabling pattern, so as to form the antenna cabling region on the outer side surface of the non-metal housing component.

It is to be understood that the covering layer is only temporarily provided on the outer side surface of the non-metal housing component to shield a region of the outer side surface of the non-metal housing component where no antenna cabling is required, so that the covering layer should be removable. In addition, the above-mentioned covering film may be replaced by an ink layer, which is not limited in the embodiments of the present disclosure.

At S300, a CPS antenna layer is formed on the antenna cabling region by means of a CPS process.

It is to be understood that a principle of the CPS process is that a solid metal is heated and gasified into a metal gas, and then the metal gas is compressed and sprayed onto a surface of a workpiece at a high speed; when sprayed onto the surface of the workpiece, the metal gas is cooled to a normal temperature and is bonded to molecules of a substrate of the workpiece, thus forming a metal layer on the surface of the workpiece. The above process does not need the assistance of vacuum or inert gas, is simple in realization principle, and has no special requirement for material of the substrate of the workpiece. For the embodiments of the present disclosure, the above-mentioned workpiece refers to the housing component. Since the metal layer obtained by means of the CPS process is used as an antenna in the embodiments of the present disclosure, it is defined that the housing component should be made of non-metal material, such as plastic.

In an embodiment, as shown in FIG. 6, S300 may include following sub-steps S310 and S320.

At S310, a solid metal is gasified into a metal gas.

In an example, endothermic gasification of the solid metal may be realized by increasing temperature, thus forming the metal gas. Here, the metal may include any one or more of copper, tin, aluminum and zinc.

At S320, the metal gas is sprayed onto the outer side surface of the non-metal housing component to form the CPS antenna layer on the antenna cabling region.

In an example, the metal gas obtained in S310 is compressed, and then the compressed metal is sprayed onto the outer side surface of the non-metal housing component at a high speed; when sprayed onto the outer side surface of the non-metal housing component, the metal gas is bonded to molecules of the non-metal housing component, thus forming a metal layer on the outer side surface of the non-metal housing component.

It is to be understood that since the covering layer is provided on the outer side surface of the non-metal housing component in advance, at S320, the CPS antenna layer is only formed in the hollowed-out region (i.e., in the antenna cabling region) of the covering layer. In this way, the CPS antenna layer matched with the preset antenna cabling pattern is formed on the outer side surface of the non-metal housing component.

In some embodiments, as shown in FIG. 6, after S320, a step S330 is further included. At S330, the covering layer on the outer side surface of the non-metal housing component is removed. The covering layer is provided at S210, and is configured to shield the region on the outer side surface of the non-metal housing component where no antenna cabling is required. After the CPS antenna layer is formed, the covering layer is removed.

In some embodiments, as shown in FIG. 6, after S330, a step S340 is further included. At S340, the non-metal housing component is cleaned.

In some embodiments, as shown in FIG. 6, after step S340, a step S350 is further included. At S350, the CPS antenna layer is polished, so that the CPS antenna layer is flush with the outer side surface of the non-metal housing component. Generally, because the covering layer has a thickness, the metal layer formed by spraying the metal gas onto the outer side surface of the non-metal housing component also has a large thickness. In order to prevent the CPS antenna layer from forming a bulge on the outer side surface of the non-metal housing component after the covering layer is removed. in the example the non-metal housing component behind the CPS antenna layer is polished to improve the flatness of the external surface of the housing component, so as to facilitate subsequent topcoat spraying. It should be noted that because the antenna layer of the embodiments of the present disclosure is formed by bonding the metal gas to molecules of the non-metal housing component by means of the CPS process, polishing does not affect the reliability of combining between the CPS antenna layer and the non-metal housing component.

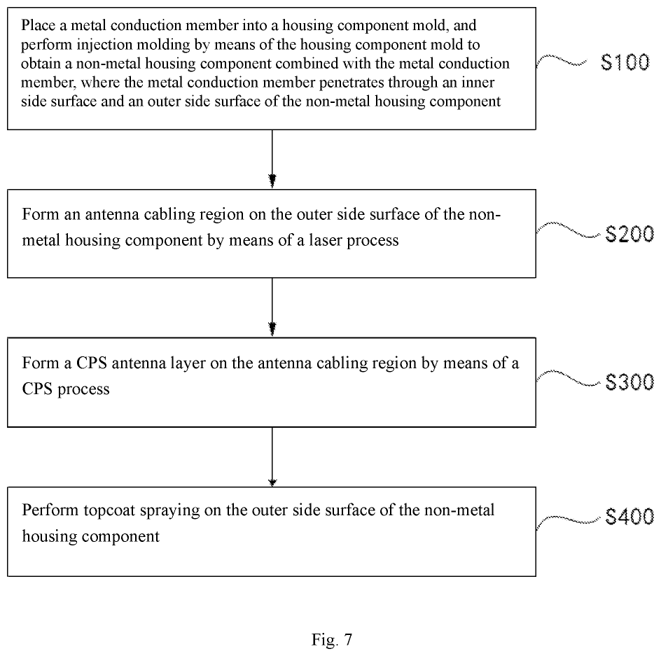

In some embodiments, as shown FIG. 7, a step S400 is further included. At S400, topcoat spraying is performed on the outer side surface of the non-metal housing component, to cover the CPS antenna layer and improve the aesthetics of the external surface of the terminal device.

The terminal device of the embodiments of the present disclosure includes a non-metal housing component, a CPS antenna layer, a mainboard and a metal conduction member. The mainboard is disposed on an inner side of the non-metal housing component. The CPS antenna layer is disposed on an outer side surface of the non-metal housing component. The metal conduction member penetrates through an inner side surface and the outer side surface of the non-metal housing component. One end of the metal conduction member is electrically connected to the CPS antenna layer, and the other end of the metal conduction member is electrically connected to the mainboard. According to the scheme of the embodiments of the present disclosure, the CPS antenna layer is formed on the outer side surface of the non-metal housing component, so the layout of antennas for multiple frequency bands is realized through the CPS antenna layer. In addition, the CPS antenna layer is electrically connected to the mainboard through the metal conduction member, so that a transceiving function of the antenna is realized. The embodiments of the present disclosure can overcome the disadvantages of the traditional FPC antenna, LDS antenna and PDS antenna, realize the arrangement of the antennas from the internal space of the terminal to the outer side surface of the terminal, and effectively solve a problem of insufficient antenna clearance space caused by tight internal space of the terminal device, thereby ensuring the performance of antennas.

According to the technical scheme of the embodiment of the present disclosure, a non-metal housing component embedded with a metal conduction member is manufactured by means of an injection molding process, and a CPS antenna layer is disposed on the non-metal housing component of the terminal device. The CPS antenna layer is electrically connected to the mainboard through the metal conduction member, thereby realizing the transmission and reception of antenna signals. The CPS antenna layer can overcome the disadvantages of the traditional FPC antenna, LDS antenna and PDS antenna, and realize the arrangement of the antennas from the internal space of the terminal device to the external surface of the terminal device, and effectively solve a problem of insufficient antenna clearance space caused by tight internal space of the terminal device, ensuring the performance of antennas.

The above is a detailed description of the preferred implementations of the present disclosure, but the present disclosure is not limited thereto. Those having ordinary skill in the art can also make various equivalent modifications or substitutions without departing from the protection scope of the present disclosure, and these equivalent modifications or substitutions all fall within the scope defined by the claims of the present disclosure.

1. A terminal device, comprising:
a non-metal housing component;
a Cold Plasma Spray (CPS) antenna layer, disposed on an outer side surface of the non-metal housing component;
a mainboard, disposed on an inner side of the non-metal housing component; and
a metal conduction member, penetrating through an inner side surface and the outer side surface of the non-metal housing component, wherein a first end of the metal conduction member is electrically connected to the CPS antenna layer, and a second end of the metal conduction member is electrically connected to the mainboard.

2. The terminal device of claim 1, wherein the non-metal housing component is a middle frame and/or a rear cover.

3. The terminal device of claim 1, further comprising:
a metal elastic connector, wherein a first end of the metal elastic connector is electrically connected to the mainboard,
a second end of the metal elastic connector elastically contacts with the metal conduction member, and
the metal conduction member is electrically connected to the mainboard through the metal elastic connector.

4. An antenna manufacturing method for the terminal device, comprising:
placing a metal conduction member into a housing component mold, and performing injection molding by means of the housing component mold to obtain a non-metal housing component combined with the metal conduction member, wherein the metal conduction member penetrates through an inner side surface and an outer side surface of the non-metal housing component;
forming an antenna cabling region on the outer side surface of the non-metal housing component by means of a laser process; and
forming a CPS antenna layer on the antenna cabling region by means of a CPS process.

5. The antenna manufacturing method for the terminal device of claim 4, wherein forming an antenna cabling region on the outer side surface of the non-metal housing component by means of a laser process comprises:
providing a covering layer on the outer side surface of the non-metal housing component; and
forming a hollowed-out region matched with an antenna cabling pattern on the covering layer by means of the laser process, and forming an antenna cabling region on the outer side surface of the non-metal housing component at the hollowed-out region.

6. The antenna manufacturing method for the terminal device of claim 4, wherein forming a CPS antenna layer on the antenna cabling region by means of a CPS process comprises:
gasifying a solid metal into a metal gas; and
spraying the metal gas onto the outer side surface of the non-metal housing component to form a CPS antenna layer on the antenna cabling region.

7. The antenna manufacturing method for the terminal device of claim 6, further comprising:
after forming the CPS antenna layer, removing the covering layer on the outer side surface of the non-metal housing component; and
cleaning the non-metal housing component.

8. The antenna manufacturing method for the terminal device of claim 6, further comprising:
polishing the CPS antenna layer to allow the CPS antenna layer to be flush with the outer side surface of the non-metal housing component.

9. The antenna manufacturing method for the terminal device of claim 4, further comprising:
polishing a part of the metal conduction member protruding out of the outer side surface of the non-metal housing component, so that one end of the metal conduction member is flush with the outer side surface of the non-metal housing component.

10. The antenna manufacturing method for the terminal device of claim 4, further comprising:
performing topcoat spraying on the outer side surface of the non-metal housing component.

11. The terminal device of claim 2, further comprising:
a metal elastic connector, wherein a first end of the metal elastic connector is electrically connected to the mainboard,
a second end of the metal elastic connector elastically contacts with the metal conduction member, and
the metal conduction member is electrically connected to the mainboard through the metal elastic connector.

12. The antenna manufacturing method for the terminal device of claim 5, further comprising:
performing topcoat spraying on the outer side surface of the non-metal housing component.

13. The antenna manufacturing method for the terminal device of claim 6, further comprising:
performing topcoat spraying on the outer side surface of the non-metal housing component.

14. The antenna manufacturing method for the terminal device of claim 7, further comprising:
performing topcoat spraying on the outer side surface of the non-metal housing component.

15. The antenna manufacturing method for the terminal device of claim 8, further comprising:
performing topcoat spraying on the outer side surface of the non-metal housing component.

16. The antenna manufacturing method for the terminal device of claim 9, further comprising:
performing topcoat spraying on the outer side surface of the non-metal housing component.
